(19) United States
(12) Patent Application Publication
(10) Pub. No.: US 2010/0030571 A1
(43) Pub. Date: Feb. 4, 2010

(54) Physician's practice aesthetic care program

(76) Inventors: Dennis R. Jones, Chesapeake, VA (US); Thomas R. Noon, Chesapeake, VA (US)

Correspondence Address: GUERRY LEONARD GRUNE, 784 S VILLIER CT., VIRGINIA BEACH, VA, 23452, US

(21) Appl. No.: 12/221,562

(22) Filed: Aug. 4, 2008

(51) Int. Cl. G06Q 50/00; G06Q 90/00; G06Q 30/00; G06Q 10/00

(52) U.S. Cl. 705/2; 705/500

(57) ABSTRACT

Disclosed is a method of generating a revenue stream by providing cosmetic medical aesthetic treatments to patients within their personal medical doctor's or other physician's (PMD's) office such that a second party business entity can provide sourcing of resources required, equipment, software, personnel hiring, operational and clinical training and consulting, development, placement and management of advertising and marketing, and a lead management system for the PMD or group of PMDs. The combining of similarly contracted physicians into an advertising and marketing group is also part of the present disclosure. Another important aspect of the disclosure is that the methods include providing a revenue sharing program between PMDs.

### FIELD OF DISCLOSURE

The present disclosure generally relates to a computer managed and/or assisted process for providing cosmetic medical aesthetic services not usually provided by primary care family or general medical practitioners. More particularly, the present disclosure relates to a process for informing patients and potential patients or customers that cosmetic medical aesthetic services are being provided by their personal medical doctors (PMD) and other physicians within a specific geographic area and or by a specific physician or physician's group. The present disclosure also allows for the inclusion of revenue sharing programs utilizing lasers, coherent or incoherent light sources or any type or kind of machinery or equipment in order to deliver the afore mentioned treatments and or services.

### BACKGROUND OF DISCLOSURE

Generally, treatment for hair removal, hair growth, reduction of fatty tissue and wrinkles and other cosmetic medical procedures by using laser or other light sources or other types of energy, medications or prescription or non prescription compounds has been performed in dermatologists' or plastic surgeons' offices. Should a patient desire these kinds of laser or other treatments, they would have to find or be referred to either a plastic surgeon or a dermatologist, leave their PMD's office, paying a co-pay for the referral and basically begin another patient—physician relationship.

The development of better and more efficient lasers and other forms of technology, better laser safety and better training now allows for cosmetic laser and other forms of technology driven procedures to occur outside the plastic surgeon's or dermatologists' offices, including within salons and spas. A very large drawback and concern affiliated with salon and/or spa treatments is that the patient is required to visit a salon or spa without a physician's personal oversight of the care and therapy rendered and often required which has resulted in unsatisfactory results and often undesirable side effects.

In addition to laser treatment for removal of unwanted hair or in some cases stimulation of hair follicles for hair growth, laser, other light and other energy sources have also been employed to heat tissue for stimulating growth of collagen fibers in soft tissue, thereby firming the surrounding skin and removing wrinkles. Wrinkles are also removed by the application of certain medications such as Botox® or the use of fillers to plump up the tissue thus removing the wrinkles.

Cosmetic medical aesthetic treatments generate revenue for dermatologists, plastic surgeons spas and salons, yet no revenue is generated for PMD's. Studies show that many patients would elect and prefer to have these treatments performed in a PMD's office by the PMD's staff and within the comfort and safety of familiar surroundings. Also, a trip to the doctor's office generates much less social inquiry as to the nature of the office visit. As seen in the media, when a noted person goes to a dermatologist or plastic surgeon, there is much speculation as to whether he/she did or didn't have any aesthetic treatments. A visit to their PMD generates much less speculation.

Presently there is a need for a method to provide laser treatments and cosmetic medical aesthetic services as mentioned above to be performed by a patient's PMD's staff office under the care and supervision of the patient's PMD. One method is for another party or parties providing, under a revenue sharing program, proper equipment in the PMD's office and could also include training, advertising, marketing and other support. In this manner, the PMD is not required to purchase, lease, make monthly payments or provide any financial assistance for the presence of the laser or other equipment, but instead provides a location for the equipment to reside for use on his/her patients in his/her office. The payment for the use of the laser or other equipment is under the revenue share program. Pooling of marketing resources can occur when a group of PMD's within the same geographical area advertise related to their cosmetic medical_aesthetic services throughout the available local media, (such advertising may be produced and placed either by the PMDs or by another party) which can be provided by this method.

### RELEVANT ART

U.S. Patent Application Publication No. 2003/0163352A1, to Surpin, et. al., and unassigned, describes a method for gainsharing of physician services between a plurality of physicians comprising the steps of: establishing a best practice norm for a plurality of classified diagnosis related groups from base patient data; determining an incentive constraint of an amount of a payment made to the physicians which is available for gainsharing; determining an incentive pool from payments made to the physicians in advance associated with the plurality of classified diagnosis related groups up to the incentive constraint; and determining distribution of the incentive pool by comparing current physician performance associated with one of the classified diagnosis related groups to the established best practice norm for said one of the classified diagnosis related groups.

U.S. Patent Application Publication No. 2006/0282287A1, to McKinley, et. al., and unassigned, describes a regulatory compliant integrated healthcare system comprising: a management entity; a medical collective consisting of and owned by a plurality individual physicians wherein the management entity has an ownership stake in the medical collective and provides management services thereto; at least one medical goods or services provider; and a cooperative agreement between the management entity, the medical collective, and the at least one medical goods or services provider, the cooperative agreement comprising a sales agreement between the management entity and the at least one medical goods or services provider whereby the management entity acts as the sales agent for the medical goods or service provider, the medical goods or services provider pays a commission to the management entity based on the sales of the medical goods or services provider's goods or services by the individual physicians of the medical collective and other physician's clients, and wherein the management entity distributes dividends from the commission to the individual physicians of the medical collective based on the individual physicians equity position in the medical collective.

U.S. Patent Application Publication No. 2006/0036454A1, to Henderson, Carlton Lindley, and unassigned, describes a business system and related methods and processes for the plural of professional consultation with the consumer and/or retail purchaser of, professional (not consumer self-service style) manufacturing and/or compounding of, packaging of, labeling of, and delivery of customized “made-to-order” retail (non-prescription, non-cosmetic) personal care products designed and intended for consumer applied, “home use” personal consumption to individual retail customers that is performed in a “while-you-wait,” “drive thru” and/or “call in—take out” retail environment by means of non-automated hand-crafting a customized, (non-prescription, non-cosmetic) personal care product to a consumer at a location remote from a second location in which a (non-prescription, non-cosmetic) personal care product base is prepared, comprising: a plurality of measuring options and devices for determining amounts of at least one of the product base and optionally, one or more customizing agents to be blended into a container; a plurality of interactive, human decision-making and labor process related to selection and application of dispensing options and devices, and/or measuring options and devices, for dispensing the amounts of at least one of the product base and optionally, one or more customizing agents into the container; a mixing device for blending the product base and optional customizing agents after being dispensed into the container by agitating the contents of the container and/or of the container itself and a labeling device and/or process for labeling the container, identifying the specific ingredients contained in the custom blended product.

PCT Application Publication No. WO05112548, to Singer et. al., and unassigned, describes a cooperative residual-benefit business method, operable in conjunction with a computer communications network, the method including the computer program driven steps of: (A) registering a first party having a potential residual benefit, (B) for at least one second party capable of actualizing the potential residual benefit, matching the at least one second party to the first party, (C) actualizing the residual benefit, and (D) respectively allocating a first portion of the actualized residual benefit to the first party and a second portion of the actualized residual benefit to the at least one second party.

### SUMMARY OF THE DISCLOSURE

One embodiment of the present disclosure is a method of providing cosmetic medical aesthetic treatments to patients within a PMD's office wherein another party provides equipment under a revenue sharing program, and the same or another party or parties provide training and services which can further include; process, sales and clinical training for the physician and the physician's staff, executive search, resource sourcing and advertising and marketing development and placement. Pooling of resources allows for combining into a group similarly contracted physicians in the revenue sharing program to share in the benefits of pooling their advertising and marketing development together as well as sharing the advertising placement and management_expenses required to support the marketing group. Responses to the pooled marketing campaigns flow through a lead flow system that directs the responses to specific PMDs based on geographic areas or other definitions of how the leads should be distributed among the cooperating PMDs in the group.

Another embodiment of the present disclosure includes a method wherein the physician is a PMD and may be trained as a family practitioner or general practitioner or in a specialty other than a primary care physician.

Another embodiment of the present disclosure includes a method wherein the equipment provided is laser equipment that is installed by a business entity, as arranged by a business entity and delivered to the PMD's office. Training is also provided to the PMD's staff on proper operation and safety of the laser equipment.

Another embodiment of this disclosure includes a method wherein the laser or other light source or other energy delivering equipment provides benefit for removal of hair, growth of hair, removal of wrinkles, smoothing of skin, correction of skin color, removal of veins, removal of tattoos, healing of acne, firming of collagen and/or removal of fat.

Another embodiment of this disclosure includes a method wherein the equipment is a laser or a light source for any cosmetic medical aesthetic procedure.

Another embodiment of this disclosure includes a method wherein the PMD provides a patient list to a second party to provide marketing and advertising of cosmetic medical aesthetic treatments being offered in the PMD's office under the direction and supervision of their PMD.

Another embodiment of this disclosure includes a method wherein there is more than one PMD performing the service, thereby forming a group of PMD's coordinated by a second party business manager for mutual benefit of sales, invoicing, advertising and marketing of the cosmetic medical aesthetic procedures. The new services may be or may not be managed separately from the PMD's primary health care practice.

Another embodiment of this disclosure includes a method wherein the PMD or group of PMD's benefit from revenue sharing enabled by the procedures related to the cosmetic medical aesthetic treatments in the PMD's offices.

Another embodiment of this disclosure is a method wherein the PMD or group of PMD's are either themselves trained or have office personnel trained in the clinical processes and or use of equipment or compounds for cosmetic medical aesthetic procedures

A method for generating a revenue stream, comprising the steps of a business entity:

providing for contacting a personal medical doctor (PMD) or other physician who generally provides medical care to a patient;

wherein said business entity is proposing a business relationship with said PMD wherein the purpose of said business relationship is to provide cosmetic medical aesthetic treatments to patients with said PMD using the office, staff, and medical assistance of said PMD;

analyzing the patient demographics and requirements of the local area PMD's to generate a pro forma analysis in order to add an additional revenue stream other than primary patient care;

providing or sourcing required resources such as equipment, software, operating manuals, training, scheduling, advertising and marketing materials of and for cosmetic medical aesthetic treatment;

optionally providing and involving a means for Botox® and or other compounds, injections or applications and or use of laser or other light source or other energy source for cosmetic medical aesthetic treatments including and not limited to removal of hair, growth of hair, removal of wrinkles, smoothing of skin, correction of skin color, removal of veins, removal of tattoos, healing of acne, firming from collagen stimulation and/or removal of fat;

communicating with the PMD's patients regarding said cosmetic medical aesthetic treatments available at the PMD's office or through other direct marketing means;

identifying additional PMD's and forming a PMD group in which each PMD in the group provides said cosmetic medical aesthetic treatments;

providing similar communications to patients of additional PMDs;

developing, placing and managing advertising and marketing identifying said PMD group providing cosmetic medical aesthetic treatments;

providing a system for receiving the inquires of potential patients responding from the advertising and marketing efforts of the PMD group and routing those inquires to the PMD's group's individual PMD offices;

training the PMD's and or their staffs in the operation and clinical aspects of delivering cosmetic medical aesthetic procedures;

assisting with the recruitment and hiring of staff for the PMD for consultation, and/or selling and/or delivering cosmetic medical aesthetic treatments; and

providing said resources that allow for scheduling, invoicing and delivery of cosmetic medical aesthetic treatments.

What is claimed is:

1. A method for generating a revenue stream for a business entity, comprising the steps of:
providing contact to a personal medical doctor (PMD) and/or other physicians within a specific geographic area and/or by a specific physician or physician's group,
wherein said business entity is proposing a business relationship with said PMD wherein the purpose of said business relationship is providing cosmetic medical aesthetic treatments to said patients with said PMD using the office, staff, and medical assistance of said PMD;
analyzing said patient demographics and requirements of said PMD in a local area to generate a pro forma analysis to add additional revenue streams other than primary patient care;
providing or sourcing resources for said cosmetic medical aesthetic treatment;
providing a means for injections, and applications including the use of laser, light source or other energy source for said cosmetic medical aesthetic treatments;
communicating with between said PMD and said patients regarding said cosmetic medical aesthetic treatments available at an office of said PMD;
identifying additional PMDs and forming a PMD group in which each PMD in said group provides said cosmetic medical aesthetic treatments;
providing similar communications to said patients of said group;
developing, placing, and managing advertising and marketing including identifying said group providing said cosmetic medical aesthetic treatments;
providing a system for receiving the inquires of potential patients responding from the advertising and marketing efforts of said group and routing said inquires to a PMD office or an office affiliated with an office of said PMD;
training said PMD and/or their staffs in the operation and clinical aspects of delivering said cosmetic medical aesthetic procedures;
assisting with the recruitment and hiring of said staff for said PMD for consultation, and/or selling and/or delivering said cosmetic medical aesthetic treatments; and
providing resources that allowing for scheduling, invoicing and delivery of said cosmetic medical aesthetic treatments.

2. The method for generating a revenue stream as in claim 1, wherein said PMD may be a family practitioner or general practitioner or in a specialty other than that of a primary care physician.

3. The method for generating a revenue stream as in claim 1, wherein said resources provided include a laser, light source, or other energy delivering equipment which is installed, arranged, and provided a business entity for said office of said PMD and wherein training is provided to said staff of said PMD regarding proper operation, safety and utility of said equipment under a revenue sharing program.

4. The method for generating a revenue stream as in claim 1, wherein said resources are software, operating manuals, training, scheduling, advertising, and materials for marketing.

5. The method for generating a revenue stream as in claim 1, wherein said cosmetic medical aesthetic treatments comprise removal of hair, growth of hair, removal of wrinkles, smoothing of skin, correction of skin color, removal of veins, removal of tattoos, healing of acne, firming from collagen stimulation and/or removal of fat.

6. The method for generating a revenue stream as in claim 1, wherein said PMD provides a list of said patients to said business entity to provide marketing and advertising of cosmetic medical aesthetic treatments being offered in an office of said PMD under the direction and supervision of said PMD.

7. The method for generating a revenue stream as in claim 1, wherein said group benefits from sharing marketing and advertising development, and/or placement, and/or management costs for any procedures related to said cosmetic medical aesthetic treatments in any of the offices of said group.

8. The method for generating a revenue stream as in claim 1, wherein said group is trained in the processes and use of said laser, said other light source, said other energy delivering equipment, Botox®, fillers and/or other compounds specifically used for said cosmetic medical aesthetic treatments.

9. A method for providing cosmetic medical aesthetic treatments comprising the steps of:
a business entity contacting a primary care physician (PMD) who generally provides primary medical care to one or more patients;
proposing a business relationship with said PMD wherein the purpose of said business relationship is to provide said cosmetic medical aesthetic treatments to said patients within the office of said PMD;
said business entity analyzing the demographics and requirements of said patients of said PMD to generating a pro forma analysis of potential additional revenue streams other than primary patient care;
said business entity providing resources for said cosmetic medical aesthetic treatments;
wherein said cosmetic medical aesthetic treatments involve Botox® or equivalent compounds, injections, applications, use of lasers, other light sources, other energy sources for removal of hair, growth of hair, removal of wrinkles, smoothing of skin, correction of skin color, removal of veins, removal of tattoos, healing of acne, firming from collagen stimulation and/or removal of fat;
said business entity communicating with said patients regarding said cosmetic medical aesthetic treatments available at said PMD's said office and identifying other PMD offices, thus forming a PMD group that provides said cosmetic medical aesthetic treatments;
said business entity providing similar communications to said patients of said PMD group;
said business entity developing, placing and managing advertising and marketing including identifying said PMD group providing said cosmetic medical aesthetic treatments;
said business entity providing a system for advertising and marketing and allowing for negotiation and placement of all said advertising in a geographic area on behalf of said PMD group;
said business entity providing a system for receiving the inquires of potential patients responding from said advertising and said marketing of said business entity and routing those inquires to said office of said PMD group;
training said PMD group and staff in the operation and clinical aspects of delivering said cosmetic medical aesthetic procedures;
assisting with the recruitment and hiring of key staff for selling and delivering said cosmetic medical aesthetic treatments.
